(19) United States
(12) Patent Application Publication
(10) Pub. No.: US 2015/0363435 A1
(43) Pub. Date: Dec. 17, 2015

(54) Declarative Virtual Data Model Management

(71) Applicant: Cisco Technology, Inc., San Jose, CA (US)

(72) Inventors: Kevin Charles Ott, Los Altos, CA (US); Panagiotis Reveliotis, Mountain View, CA (US)

(21) Appl. No.: 14/303,805

(22) Filed: Jun. 13, 2014

(51) Int. Cl. G06F 17/30

(52) U.S. Cl. CPC G06F 17/30294

(57) ABSTRACT

Presented herein are declarative virtual data model management techniques, sometimes referred to herein more simply as declarative management techniques, for creating, controlling, and managing the lifecycles of virtual enterprise data models. In one example, a data virtualization server receives a Data Definition Language (DDL)-based introspection statement that statement identifies a data source resource. The data virtualization server connects to the data source resource identified in the DDL-based introspection statement and introspects the data source resource identified in the DDL-based introspection statement. The introspected data source resource is used to form at least part of a virtual enterprise data model.

### TECHNICAL FIELD

The present disclosure relates to data virtualization.

### BACKGROUND

Data virtualization generally refers to an approach for managing data from a plurality of different data sources (e.g., databases, application, systems, storage, etc.) at a centralized node (e.g., server). Data virtualization may utilize a virtual database, referred to herein as a virtual data mode or virtual enterprise data model, at the centralized node that is the aggregation of the data from the disparate data sources. In general, the virtual enterprise data model provides a layered virtual view of the data from the different data sources such that all of the data is accessible from clients (e.g., computers, applications, dashboards, etc.) through the virtual enterprise data model. As such, a client can retrieve and manipulate data without requiring details about, for example, how the data is formatted, where the data is physically located, etc.

### BRIEF DESCRIPTION OF THE DRAWINGS

FIG. 1 is a block diagram of a computing network in which declarative virtual data model management techniques may be implemented according to an example embodiment.

FIG. 2A is a schematic diagram of a computing network in which an introspection method in accordance with examples presented herein may be implemented according to an example embodiment.

FIG. 2B is flowchart of an introspection method according to an example embodiment.

FIG. 3A is a schematic diagram of a computing network in which a statistics collection method may be executed according to an example embodiment.

FIG. 3B is flowchart of a statistics collection method according to an example embodiment.

FIG. 4A is a schematic diagram of a computing network in which a virtual table removal method may be executed according to an example embodiment.

FIG. 4B is flowchart of a virtual table removal method according to an example embodiment.

FIG. 5A is a schematic diagram of a computing network in which a virtual data service deployment may be executed according to an example embodiment.

FIG. 5B is flowchart of a virtual data service deployment method according to an example embodiment.

FIG. 6A is a schematic diagram of a computing network in which a view definition method may be performed according to an example embodiment.

FIG. 6B is flowchart of a view definition method according to an example embodiment.

FIG. 7A is a schematic diagram of a computing network in which a caching method in may be performed according to an example embodiment.

FIG. 7B is flowchart of a caching method in accordance with examples presented herein.

FIG. 8A is a schematic diagram of a computing network in which a server query method may be performed according to an example embodiment.

FIG. 8B is flowchart of a server query method according to an example embodiment.

FIG. 9A is a schematic diagram of a computing network in which a cache query method may be implemented according to an example embodiment.

FIG. 9B is flowchart of a cache query method according to an example embodiment.

FIG. 10 is a high-level flowchart of a method according to an example embodiment.

FIG. 11 is a block diagram of a client in which the techniques presented herein may be performed according to an example embodiment.

### DESCRIPTION OF EXAMPLE EMBODIMENTS

### Overview

Presented herein are declarative virtual data model management techniques, also referred to herein more simply as declarative management techniques, for creating, controlling, and managing the lifecycles of virtual enterprise data models. In one example, a data virtualization server receives a Data Definition Language (DDL)-based introspection statement that identifies a data source resource. The data virtualization server connects to the data source resource identified in the DDL-based introspection statement and introspects the data source resource identified in the DDL-based introspection statement. The introspected data source resource is used by the data virtualization server to form at least part of a virtual enterprise data model.

### Example Embodiments

The declarative virtual data model management techniques, referred to herein more simply as declarative management techniques, utilize a declarative virtual data model management computer language to perform the activities typically involved in the definition and management of virtual data models, including: introspection, customization, composition, caching, and Virtual Data Service Deployment. In general, the declarative virtual data model management computer language builds on top of the concepts and syntax used by the Data Definition Language (DDL) specification, the Uniform Resource Identifier (URI) specification, and the JavaScript Object Notation (JSON) specification. A brief description of each of these specifications is provided first before describing the details of the declarative management techniques and the associated declarative virtual data model management computer language.

The DDL is a standard subset of the Structured Query Language (SQL). DDL is typically used to manage the physical artifacts composing the user data models defined within a Relational Database Management System (RDBMS). For example, DDL includes “CREATE,” “ALTER” and “DROP” statements that enable DDL to be used to create, modify or delete, respectively, a relational table used to store and retrieve user data. In the examples presented herein, these DDL concepts are expanded beyond physical RDBMS systems to meet the needs of virtual enterprise data models employed by data virtualization layers, logical data warehouses, and other heterogeneous data environments.

As noted, the declarative management techniques also build upon the URI syntax. A URI is a sequence of characters used to identify a name of a web resource. This identification enables interaction with representations of the web resource over a network using specific protocols. A URI can be further classified as a Uniform Resource Locator (URL), a Uniform Resource Name (URN), or both a URL and a URN. URLs are a type of URIs that, in addition to identifying a resource, also provide a mechanism for locating the resource by describing its primary access mechanism (e.g., the network location of the resource). URNs refer to URIs under the “urn” scheme that remain globally unique and persistent even when the resource ceases to exist or becomes unavailable. In general, URNs define a resource's identity, while URLs further provide a mechanism for locating the resource.

The URI syntax consists of a hierarchical sequence of elements referred to as the: (1) scheme, (2) authority, (3) path, (4) query, and (5) fragment. More specifically, each URI begins with a scheme name (“scheme”) that refers to a specification for assigning identifiers within that scheme. As such, the URI syntax is a federated and extensible naming system wherein each scheme's specification may further restrict the syntax and semantics of identifiers using that scheme. A scheme name consists of a sequence of characters beginning with a letter and followed by any combination of letters, digits, plus (“+”), period (“.”), or hyphen (“-”).

Furthermore, many URI schemes include a hierarchical element (“authority) for a naming authority so that governance of the name space defined by the remainder of the URI is delegated to that authority (which may, in turn, delegate it further). The generic syntax provides a common means for distinguishing an authority based on a registered name or server address, along with optional port and user information. The authority component is preceded by a double slash (“//”) and is terminated by the next slash (“/”), question mark (“?”), or number sign (“#”) character, or by the end of the URI.

The authority may include user information (userinfo) (“@”) and host (“:” port). URI producers and normalizers may omit the “:” delimiter that separates host from port if the port component is empty. Some schemes do not allow the userinfo and/or port subcomponents. The userinfo subcomponent may consist of a user name and, optionally, scheme-specific information about how to gain authorization to access the resource. The user information, if present, is followed by a commercial at-sign (“@”) that delimits it from the host.

The URI path component contains data, usually organized in hierarchical form, that, along with data in the non-hierarchical query component, serves to identify a resource within the scope of the URI's scheme and naming authority (if any). The path is terminated by the first question mark (“?”) or number sign (“#”) character, or by the end of the URI. A path consists of a sequence of path segments separated by a slash (“/”) character. A path is always defined for a URI, though the defined path may be empty (zero length). Use of the slash character to indicate hierarchy is only required when a URI will be used as the context for relative references. The fragment component of a URI allows indirect identification of a secondary resource by reference to a primary resource and additional identifying information. The identified secondary resource may be some portion or subset of the primary resource, some view on representations of the primary resource, or some other resource defined or described by those representations. A fragment identifier component is indicated by the presence of a number sign (“#”) character and terminated by the end of the URI.

Additionally, the declarative management techniques presented herein also build upon the JSON syntax. JavaScript Object Notation (JSON) is a text format for the serialization of structured data. It is derived from the object literals of JavaScript, as defined in the ECMAScript [ECMA] Programming Language Standard, Third Edition. JSON can represent four primitive types (strings, numbers, booleans, and null) and two structured types (objects and arrays). A string is a sequence of zero or more Unicode characters. An object is an unordered collection of zero or more name/value pairs, where a name is a string and a value is a string, number, Boolean, null, object, or array. An array is an ordered sequence of zero or more values.

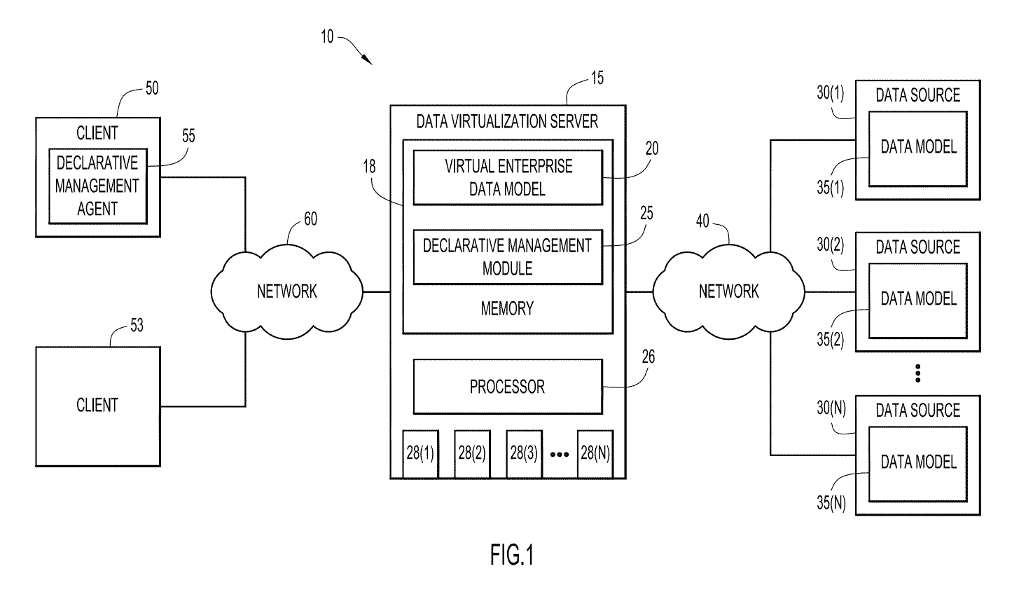

FIG. 1 is a block diagram of a computing network 10 in which declarative management techniques in which accordance with examples presented herein may be implemented. As shown, the computing network 10 comprises a data virtualization server 15 that includes a memory 18 storing data for a virtual enterprise data model 20 and instructions for a declarative management module (declarative management logic) 25. The data virtualization server 15 comprises a processor 26 and one or more network interface devices 28(1)-28(N).

Memory 18 may comprise read only memory (ROM), random access memory (RAM), magnetic disk storage media devices, optical storage media devices, flash memory devices, electrical, optical, or other physical/tangible memory storage devices. The processor 26 is, for example, a microprocessor or microcontroller that executes instructions for the declarative management module 25. Thus, in general, the memory 150 may comprise one or more tangible (non-transitory) computer readable storage media (e.g., a memory device) encoded with software comprising computer executable instructions and when the software is executed (by the processor 26) it is operable to perform the declarative management operations of data virtualization server 15.

The computing network 10 also comprises data sources 30(1) to 30(N) that include a corresponding data model 35(1) to 35(N), respectively. Also shown in FIG. 1 are client 53 and client 50. Client 50 includes a declarative management agent 55 that is associated with the declarative management module 25 and, along with the declarative management module, facilitates the operations of the declarative management techniques. As described further below, the declarative management agent 55 may comprise an SQL editor program (SQL editor) and a client driver program that enables the SQL editor program to connect to the data virtualization server 15.

The data sources 30(1)-30(N) communicate with the data virtualization server 15 via a network 40, while the clients 50 and 53 communicate with the data virtualization server 15 via a network 60. The networks 40 and 60 may be, for example, local area networks (LANs), wide area networks (WANs), etc. It is to be appreciated that the specific arrangement of FIG. 1 is merely one example arrangement and that the declarative data virtualization management techniques may be implemented in other computing networks.

The foundation of virtual enterprise data model 20 is the data extracted (introspected) from the data sources 30(1)-30(N). That is, virtual enterprise data model 20 relies on multiple data sources 30(1)-30(N) that may be of the same or different type (e.g., relational, file-based, cloud-based, etc.). Each data source 30(1)-30(N) may be named and hosted on a globally addressable server and are securely accessed through a number of user accounts. The data sources 30(1)-30(N) may also comprise multiple, potentially hierarchically organized, resources (e.g. tables within schemas and catalogs) represented by the corresponding data model 35(1)-35(N). The virtual enterprise data model 20 may utilize all or a subset of the data source resources (i.e., the resources available at data sources 30(1)-30(N)).

Data sources 30(1)-30(N) may each include a plurality of resources that are typically combined to form the virtual enterprise data model 20. The virtual enterprise data model 20 is composed of different layers of data views that can be in turn are used to define enterprise data services. More specifically, virtual enterprise data model 20 may comprise a set of hierarchically organized data assets, including data sources, data views and data services. In accordance with the declarative management techniques (enabled by declarative management module 25 and declarative management agent 55), the characteristics of the resources of data source resources 30(1)-30(N) involved in the definition of virtual enterprise data model 20 are mapped to the syntax components of hierarchical URIs in order to define a declarative definition syntax, that can be used to express the definition of the foundation of the virtual enterprise data model 20 in a concise and uniform manner.

The characteristics of a data source resource that may be used to define an enterprise data model may include, for example: (1) heterogeneity, (2) host addressability, (3) secure addressability, (4) naming, and (5) resource hierarchy. Data source heterogeneity refers to the differences in the supported data models, data types and data processing capabilities across different kinds of data sources (e.g. hierarchical data models vs. relational data models, or data types supported by different vendors, or the SQL functions supported by different vendors). Data sources are host-addressable in the sense that their data sets can be accessed through API's that are made available on host servers that have a unique physical IP address. Data sources are also addressable in a secure manner in the sense that user-specific access control policies can be applied to their data sets. In such cases, to be fully-specified, the address of the data source is extended with the account information of the user that accesses the data source. Data sources may be named in the sense that multiple distinct instances of the same data source kind using unique names may be hosted on the same server. In such cases, to be fully-specified, the address of the data source is extended with the data source name. Data sources support resource hierarchies in the sense that their data sets may be organized in hierarchical fashion (e.g. tables contained within containers, which might in turn be contained within other containers).

In the declarative definition syntax, the heterogeneity characteristic of a data source resource is mapped to the URI scheme component. Additionally, the host addressability characteristic is mapped to the URI authority host and port component, and the secure accessibility characteristic is mapped to the URI user information component. As described further below, a “SET CREDENTIAL” clause is also added. The naming characteristic of the data source resource is mapped to the URI path component. Finally, the resource hierarchy and resource selection characteristics are mapped to the URI fragment component.

During its lifecycle, virtual enterprise data model 20 may evolve by having new resource definitions added to the model. Additionally, existing resource definitions may be updated and, occasionally, certain data resources are removed from the virtual enterprise data model 20. In accordance with the declarative management techniques, DDL-like syntactic constructs (i.e., CREATE, ALTER and DROP statements) are extended and used as the backbone of a unified metadata language to express the lifecycle events of assets defined in the virtual enterprise data model 20. That is, DDL statements (DDL syntax) are used as the basis for statements forming the declarative virtual data model management computer language that enables users to define and access (query) the virtual enterprise data model 20. As such, the declarative virtual data model management computer language is referred to herein as a DDL-based virtual data model management language or, more simply, DDL-based management language.

The DDL-based management language allows for the set of virtual model management tasks (e.g., introspection, customization, composition, caching, and/or virtual data service deployment) to be expressed in a human-readable, declarative and programmable format. The employment of the DDL-based constructs eliminates the use of a complex and cumbersome programmatic application programming interface (API)-based approach to manage the metadata lifecycle, as required by conventional data virtualization techniques.

Another aspect of the declarative management techniques is the employment of JSON as the flexible and extensible mechanism to capture the specification of the properties of the data assets defined in virtual enterprise data model 20. JSON's support for hierarchical data structures is suited for the organizational characteristics of the models which typically require support for hierarchies across several dimensions.

The generic form of the DDL-based virtual data model management language (DDL-based management language) may be defined as:
Action Clause: CREATE|ALTER|DROP
Target Resource Clause: RESOURCE “resourceIdentifier” OF TYPE “resourceType”
Name Clause: SET NAME “name”
Annotation Clause: SET ANNOTATION “annotation”
Properties Clause: SET PROPERTIES “jsonFormattedResourceProperties”
Resource type-dependent Clauses

The Action and Target Resource clauses are required, while all other clauses are optional. The resourceIdentifiers may be simple names or hierarchically organized identifiers and the list of supported resourceTypes includes data sources, virtual data services, and virtual data views.

The optional Name clause may be used in an ALTER statement to rename the specified resource and the optional Annotation clause may be used to provide a human readable description of the specified resource. The optional Properties clause may be used to define introspection or customization properties of the specified resource.

For resources of data source type, the resource type-dependent clauses include the following clauses:
(Re)introspection Clause: SET URI “uri”|DROP URI “uri”|ADD URI “uri” DROP URI “uri”
Credentials Clause: SET (ENCRYPTED)? CREDENTIAL “password”
Statistics Clause: (CREATE|DROP) STATISTICS

The “uri” is a URI encoding the type, owner, host, hierarchical organization and identifiers of data sources, data source containers or individual data source resources. In particular, the URI scheme is used to encode the data source type. For server-based data sources, the URI authority is used to encode the owner user name (optional), as well as the host name and port of the server hosting the data source. The URI path is used to encode the data source identifier. For file system-based data sources, the URI absolute path is used to encode the file system location of the data source. The URI fragment is used to encode one or more data source containers (if applicable) and or data source resources by using a scheme of dot (.)—separated hierarchical names and comma (,)—separated containers or resources. The “password” is the data source owner user password in clear or encrypted form. Specific URI examples are described in greater detail below.

For resource of published data view type, the resource type-dependent clauses include the following clauses:
Definition Clause: DEFINE AS “sqlDefinition”
Materialization Clause: SET (MATERIALIZED|VIRTUAL)
   where: “sqlDefinition” is SQL-92 based definition of the data view extended to support hierarchical resource identifiers.

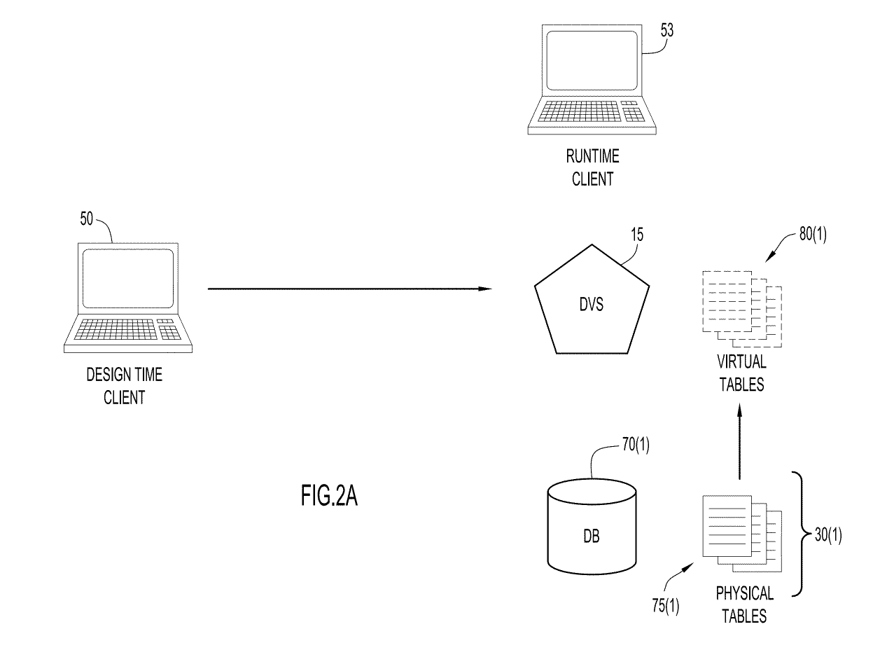

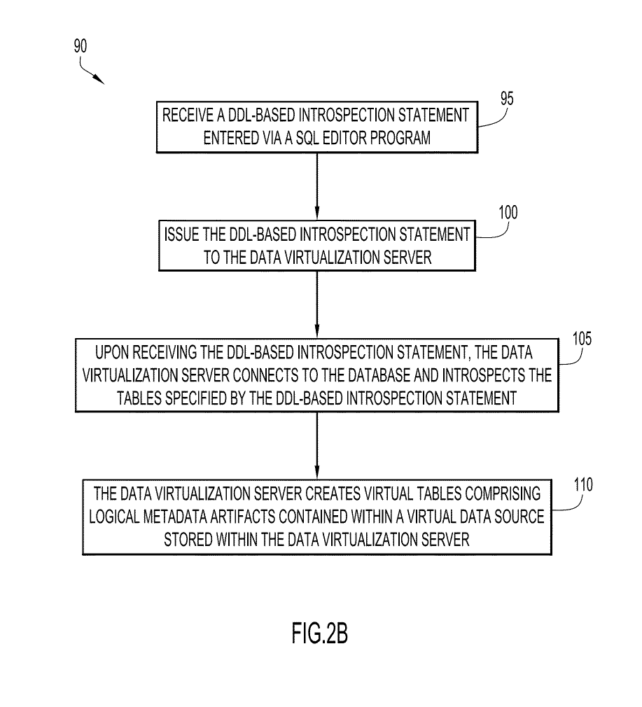

FIGS. 2A-9B provide examples illustrating how the lifecycle management of virtual data models in several use cases can be formulated in terms of the DDL-based management language. For ease of illustration, the examples of FIGS. 2A-9B will be described with reference to variations of computing network 10 of FIG. 1

More specifically, FIGS. 2A and 2B are a schematic diagram and a flowchart, respectively, which illustrate the use of the DDL-based management language for introspection. FIG. 2A illustrates the data virtualization server 15, the first client 50, the second client 53, and the data source 30(1). The first client 50 is sometimes referred to herein as a “design time client” as it is a client device used by a data developer to create and/or manage the data a virtual enterprise data model (not shown in FIG. 2A). The second client 53 is sometimes referred to herein as a “runtime client” as it is a client device used to access the virtual enterprise data model that is built on data virtualization server 15. The data source 30(1) is a server (server name=dvbu-dblab9:1521) that hosts a database 70(1). The database 70(1) is accessible through a specific set of user credentials. The database 70(1) includes a schema (PFN) that contains a set of database tables 75(1). As described further below, the database tables 75(1) may be used to create virtual tables 80(1) at the data virtualization server 15.

The flowchart of FIG. 2B illustrates an introspection method 90 corresponding to the arrangement of FIG. 2A. Method 90 starts at 95 where design time client 50 (e.g., desktop computer, laptop computer, etc.) receives a DDL-based introspection statement entered by a data developer. The DDL-based introspection statement is received via a SQL editor program (e.g., SQuirrel SQL client) that may be part of a declarative client agent 50 (FIG. 1) of the design time client 50. More specifically, all the resources defined under the PFN schema inside the database 70(1) with the service name VREPO1 located at server dvbu-dblab9:1521, that are accessible to the user PFN with the password token PASSWORD can be introspected and inserted into a virtual data model, as a data source named myNAMEdatasource, by issuing the following DDL-based introspection statement (51).

Statement S1:

create resource /myNAMEdatasource
of type “data_source”
set uri “NAME://pfn@dvbu-dblab9:1521/VREPO1#PFN”
set encrypted credential “B0873483C56F7498”

where “B0873483C56F7498” in this example is the encrypted form of the password token PASSWORD based on the encryption scheme used by the virtualization server hosting the specified virtual data model.

In accordance with examples presented herein, the DDL-based introspection statement S1, as well as other DDL-based statements described below, could be pre-authored in a plain text script file and then executed as a batch using a graphical or command line tool. It is to be appreciated that statement S1, as well as the other statements provided herein, are merely illustrative and various changes/modifications to both the statement content and format are within the scope of the examples presented herein.

The design time client 50 may be configured with a client driver program (e.g., JDBC driver) that may be part of a declarative client agent 50 (FIG. 1) so as to enable the SQL editor to connect to the data virtualization server 15. As such, at 100, the DDL-based introspection statement is issued to the data virtualization server 15. It is to be appreciated that the use of a JBDC driver is merely one example and other data transfer protocols supported by graphical or command line tools, such as Open Database Connectivity (ODBC), ADO.NET or Hypertext Transfer Protocol (HTTP) Representational state transfer (REST) could also be used to submit the DDL-based introspection statement to the data virtualization server.

At 105, upon receiving the DDL-based introspection statement, the data virtualization server 15 connects to the database 70(1) and introspects the data source resources (e.g., tables) specified by the DDL-based introspection statement. At 110, the data virtualization server 15 utilizes the introspected data source resources to form part of a virtual enterprise data model. More specifically, the data virtualization server 15 may create virtual tables 80(1) comprising logical metadata artifacts contained within a virtual data source stored within the data virtualization server 15, which reflect the properties of the introspected tables.

FIGS. 2A and 2B illustrate initial introspection of tables 75(1) of the database 70(1). It is to be appreciated that DDL-based statements may also be issued for re-introspection of tables. For example, at a later point the data developer may create the following DDL-based statement (S2) and submit it to the data virtualization server 15.

Statement S2:

alter resource /myNAMEdatasource
of type “data_source”
add uri “#PFL,PFS.CUSTOMERS”

Upon receiving statement S2, the data virtualization server 15 reconnects to the database 70(1) denoted by the logical data source referenced in the DDL-based statement S2 (myNAMEdatasource) and re-introspects the tables specified in the statement (i.e. all tables under the PFL schema as well as the CUSTOMERS tables under the PFS schema), thus creating additional virtual tables corresponding to the newly introspected tables.

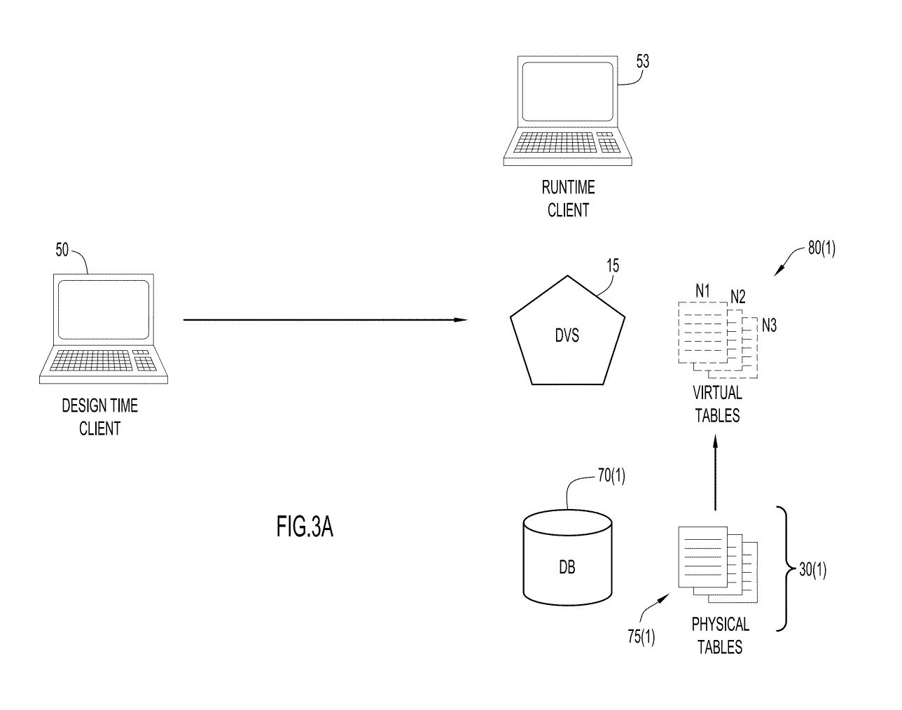

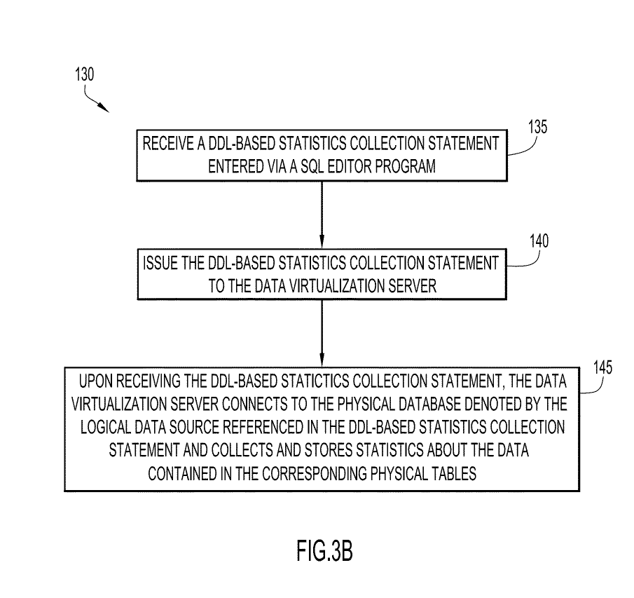

In further examples, statistics (e.g. row count) about the resources of a given data source may be collected or refreshed. More specifically, FIGS. 3A and 3B are a schematic diagram and a flowchart, respectively, which illustrate the use of the DDL-based management language for statistics collection. More specifically, FIG. 3A illustrates the arrangement of FIG. 2A comprising the data virtualization server 15, the design time client 50, the runtime client 53, and the data source 30(1).

The flowchart of FIG. 3B illustrates a statistics collection method 130 corresponding to the arrangement of FIG. 3A. Method 130 starts at 135 where design time client 50 receives the following DDL-based statistics collection statement (S3) entered by a data developer via an SQL editor.

Statement S3:

```
  alter resource /myNAMEdatasource
  of type “data_source”
collect statistics
```

As noted, the design time client 50 may be configured with a client driver program that allows the SQL editor to connect to the data virtualization server 15. As such, at 140, the DDL-based statistics collection statement is issued to the data virtualization server 15. At 145, upon receiving the DDL-based statistics collection statement, the data virtualization server 15 connects to the physical database denoted by the logical data source referenced in the DDL-based statistics collection statement (myNAMEdatasource) and collects and stores statistics about the data contained in the corresponding physical tables (e.g. row counts). In other words, the DDL-based statistics collection statement identifies a logical (virtual) data source of the virtual enterprise data model. The data virtualization server 15 uses the information in the DDL-based statistics collection statement to connect to the physical data source corresponding to the logical data source referenced in the DDL-based statistics collection statement. The data virtualization server 15 then collects and stores statistics about the data contained in the physical data source.

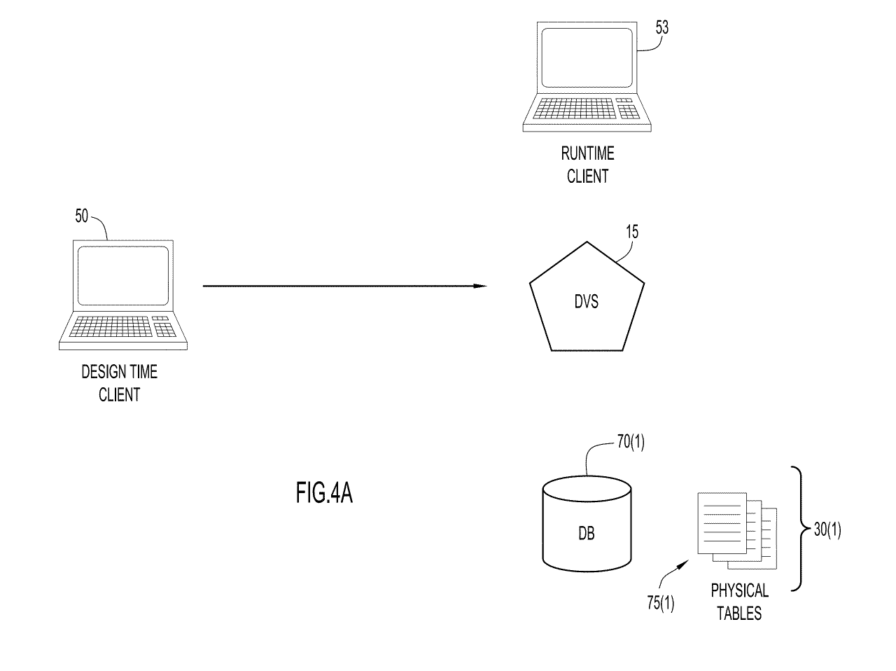

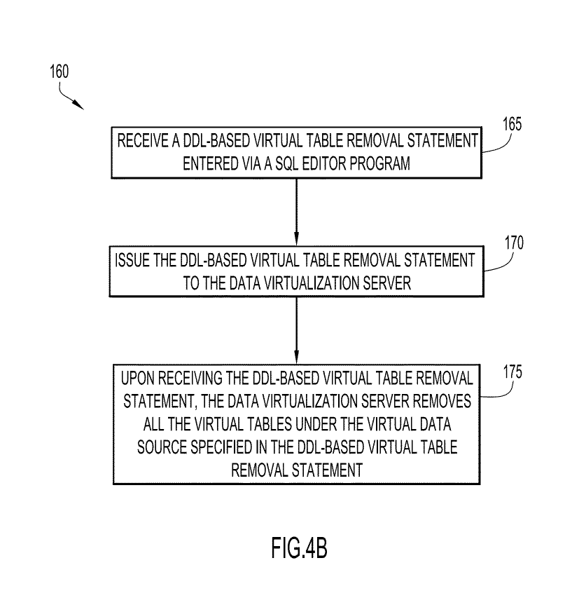

FIGS. 4A and 4B are a schematic diagram and a flowchart, respectively, which illustrate the use of the DDL-based management language for removal of virtual tables from the data virtualization server. More specifically, FIG. 4A illustrates the arrangement of FIG. 2A comprising the data virtualization server 15, the design time client 50, the runtime client 53, and the data source 30(1).

The flowchart of FIG. 4B illustrates a virtual table removal method 160 corresponding to the arrangement of FIG. 4A. Method 160 starts at 165 where design time client 50 receives the following DDL-based virtual table removal statement (S4) entered by a data developer via an SQL editor.

Statement S4:

drop resource /myNAMEdatasource
of type “data_source”

As noted, the design time client 50 may be configured with a client driver program that allows the SQL editor to connect to the data virtualization server 15. As such, at 170, the DDL-based virtual table removal statement is issued to the data virtualization server 15. At 175, upon receiving the DDL-based virtual table removal statement, the data virtualization server 15 removes all the virtual tables under the logical data source specified in the DDL-based virtual table removal statement.

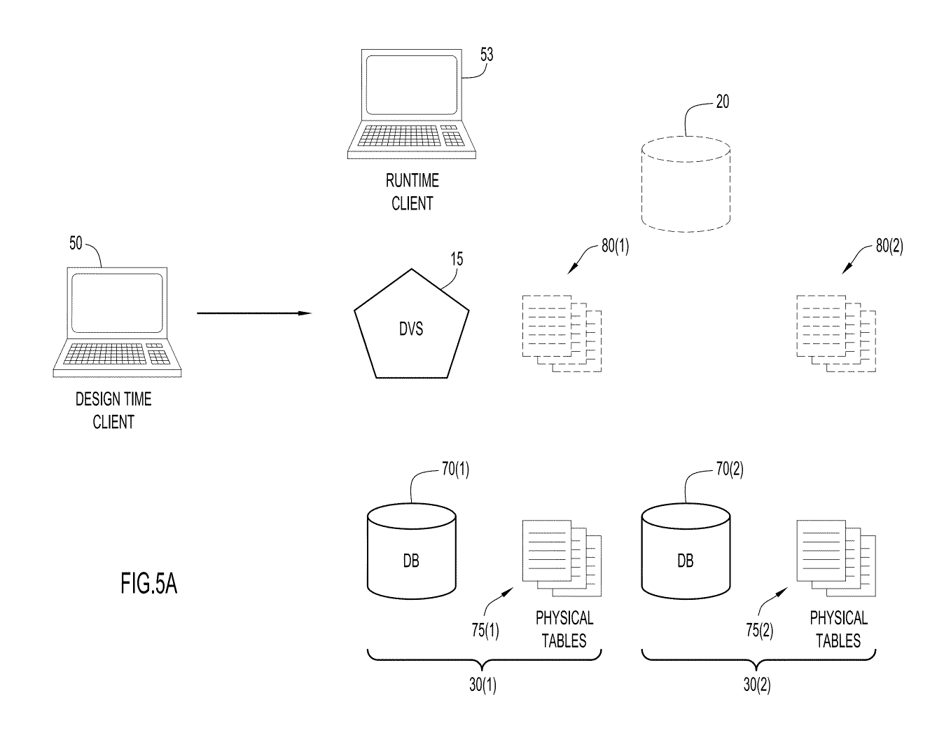

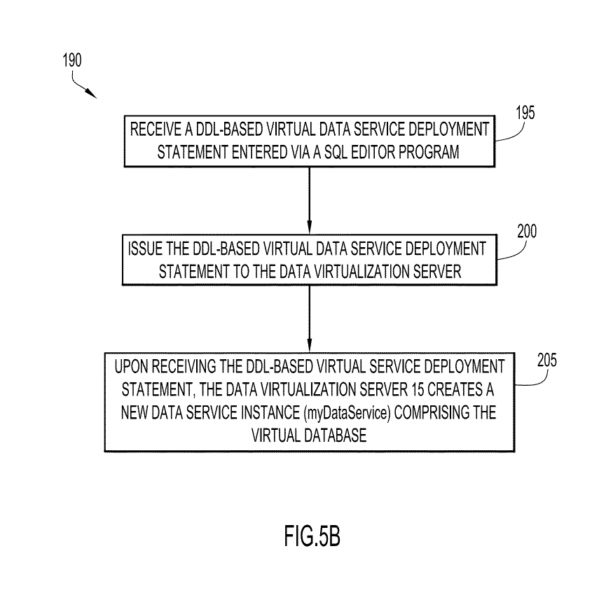

Virtual data services are containers of virtual data views. FIGS. 5A and 5B are a schematic diagram and a flowchart, respectively, which illustrate the use of the DDL-based management language for deployment of a virtual data service. More specifically, FIG. 5A illustrates a modification of the arrangement of FIG. 2A that further comprises the virtual enterprise data model 20 created at the data virtualization server 15. FIG. 5A also illustrates the design time client 50, the runtime client 53, the data source 30(1), and a second data source 30(2) that includes a database 70(2) with physical tables 75(2).

The flowchart of FIG. 5B illustrates a virtual data service deployment method 190 corresponding to the arrangement of FIG. 5A. Method 190 starts at 195 where design time client 50 receives the following DDL-based virtual data service deployment statement (S5) entered by a data developer via an SQL editor.

Statement S5:

create resource /myDataService
of type “data_service”

As noted, the design time client 50 may be configured with a client driver program that allows the SQL editor to connect to the data virtualization server 15. As such, at 200, the DDL-based virtual data service deployment statement is issued to the data virtualization server 15. At 205, upon receiving the DDL-based virtual data service deployment statement, the data virtualization server 15 creates a new data service instance (myDataService) as part of the virtual enterprise data model 20.

In an alternative example of FIGS. 5A and 5B, a virtual data service can be removed by issuing the following DDL-based drop statement (S6) to the data virtualization server 15:

Statement S6:

drop resource /myDataService
of type “data_service”

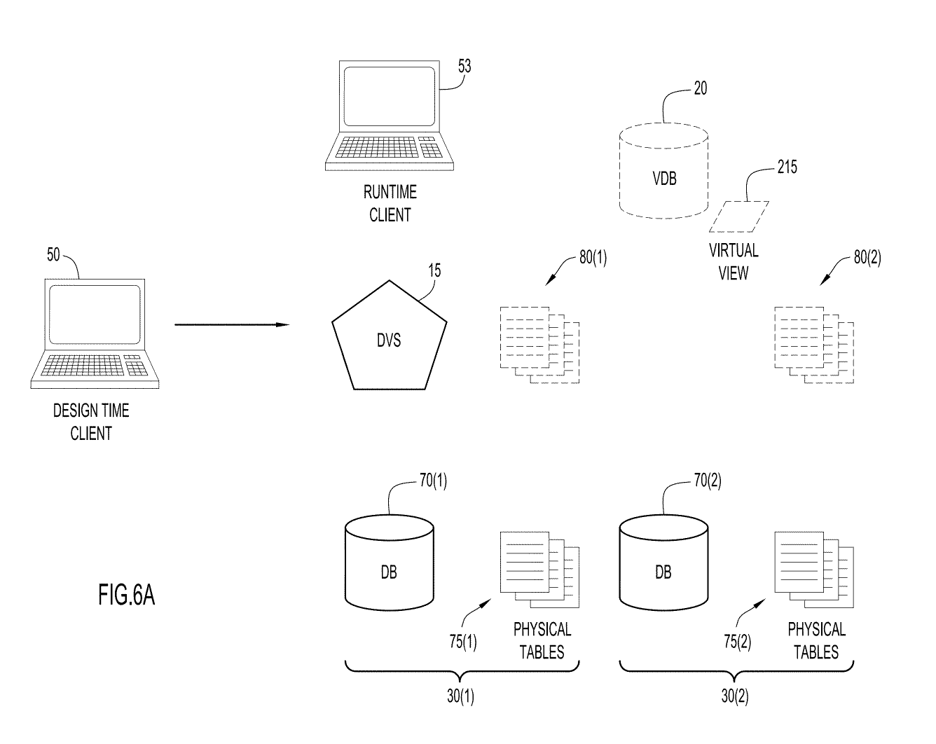

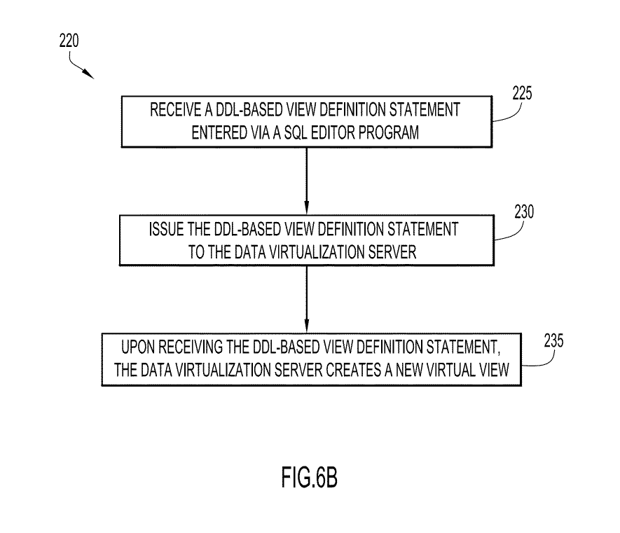

Once data sources have been defined, their resources can be used to define data views published within virtual data services. FIGS. 6A and 6B are a schematic diagram and a flowchart, respectively, which illustrate the use of the declarative management syntax for creating a view definition. More specifically, FIG. 6A illustrates a modification of the arrangement of FIG. 6A that further comprises a virtual data view (virtual view) 215 created as part of the virtual enterprise data model 20 at the data virtualization server 15. FIG. 6A also illustrates the design time client 50, the runtime client 53, the data source 30(1), and the second data source 30(2).

The flowchart of FIG. 6B illustrates a view definition method 220 corresponding to the arrangement of FIG. 6A. Method 220 starts at 225 where design time client 50 receives the following DDL-based view definition statement (S7) entered by a data developer via an SQL editor.

Statement S7:

```
create resource /myDataService/CaliforniaSalesVsPromotions
of type “data_view”
set annotation “Daily California Sales vs. Promotions”
define as
select
  total, sale_date, promotion
from
    /myNetezzaDatasource/MRKT/CAMPAIGNS/PROMOTIONS P
    LEFT OUTER JOIN
  (select
  sum(sale_price) total, sale_date
  from
  /myNAMEdatasource/PFN/SALE
where
      state = ‘CA’
group by
  sale_date
  order by
  total) S
      ON P.sale_date = S.sale_date;
```

As noted, the design time client 50 may be configured with a client driver program that allows the SQL editor to connect to the data virtualization server 15. As such, at 230, the DDL-based view definition statement is issued to the data virtualization server 15. At 235, upon receiving the DDL-based view definition statement, the data virtualization server 15 creates a new virtual view (CaliforniaSalesVsPromotions), defined based on the specification in statement S7 and published under the virtual data service specified in statement S7 (myDataService). In other words, the DDL-based view definition statement identifies a virtual data service and a virtual view to be created that correspond to the virtual data service. Using the information in the DDL-based view definition statement, the data virtualization server 15 creates the identified virtual view.

Additionally, resources from multiple data sources (e.g., data sources 30(1) and 30(2) in FIG. 6A) may be combined to define a view. Furthermore, data views may be composed to define other views using, for example, statement S8 shown below.

Statement S8:

```
create resource /myDataService/CaliforniaSalesVsPromotions
of type “data_view”
set annotation “Daily California Sales vs. Promotions”
define as
  select
  total, sale_date, promotion
  from
      /myNetezzaDatasource/MRKT/CAMPAIGNS/PROMOTIONS P
      LEFT OUTER JOIN
  /myDataServices/CaliforniaSales S
  ON P.sale_date = S.sale_date;
```

Data views may be removed by issuing, for example, statement S0 shown below.

Statement S9:

drop resource /myDataService/CaliforniaSales
of type “data_view”

As noted above, the JSON syntax may be used in order to specify resource properties. More specifically, for loosely structured, un-typed data sources, such as delimited files, introspection properties may be used to specify the data range and schema (i.e. column names and types) of the data source resources upon introspection. An example such statement is shown below as statement S10.

Statement S10:

```
create resource /CustomerGainLoss_Excel_Worksheets
of type ″data_source″
set annotation “Customer Gain Loss Scenarios”
set properties {″introspectionProperties″ :
        {″CustomerGainLossReport v4.xlsx/Scenario1″ :
          { ″dataRange″ : ″B3:E4″,
                          ″schema″ :
                              [{″US_State″:″varchar(50)″},
                              {″GainLoss″:″decitnal(10,2)″}]
                          },
        ″CustomerGainLossReport v4.xlsx/Scenario2″ :
          { ″dataRange″ : ″B62:E64″,
                            ″schema″ :
                              [{″US_State″:″varchar(50)″},
                              {″GainLoss″:″decimal(10,2)″},
                              {″Comment″:″varchar(100)″}]
                            }
          }
        }
set uri
″MsExcel://file:///D:/DATA#CustomerGainLossReport%20v4%2Exlsx.-
Scenario1,CustomerGainLossReport%20v4%2Exlsx.Scenario3″;
```

In this example (statement S10) the data source comprises two worksheets, namely Scenario1 and Scenario2 found inside an Excel file located at “D:/DATA/CustomerGainLossReport v4.xlsx”. Special characters (space and dot) have been URL-escaped (to %20 and %2E respectively). Introspection properties have been used to specify that worksheet Scenario1 contains data ranging from upper left cell B3 to lower right cell E4 comprising two columns named US_State and GainLoss of type varchar(50) and decimal(10,2) respectively. Similarly, worksheet Scenario2 contains data ranging from upper left cell B62 to lower right cell E64 comprising three columns named US_State, GainLoss and Comment of type varchar(50), decimal(10,2) and varchar(100), respectively.

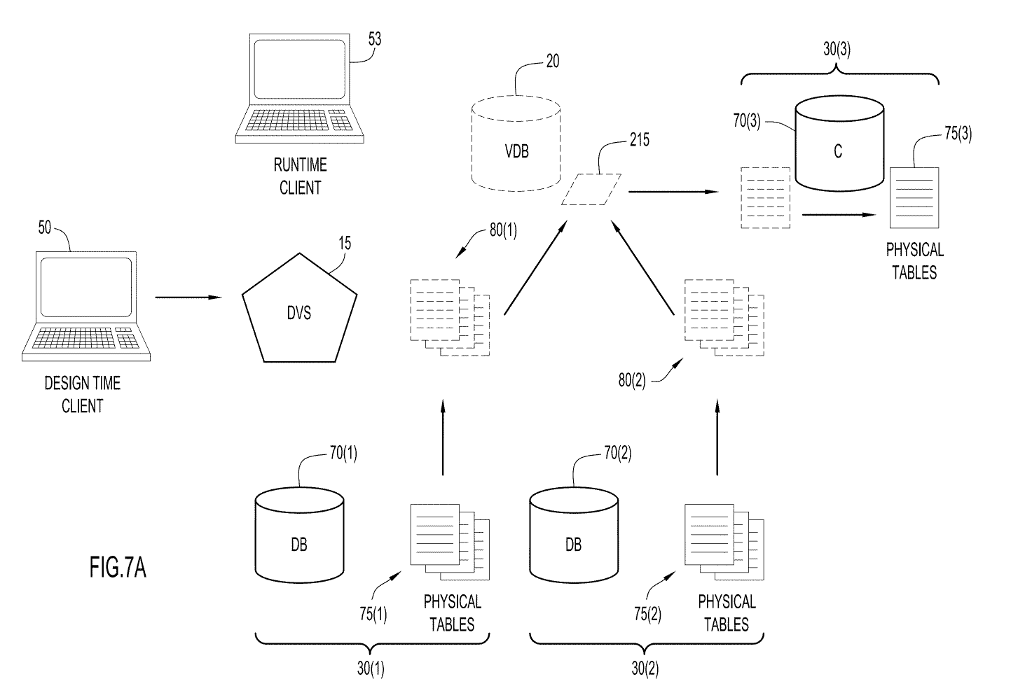

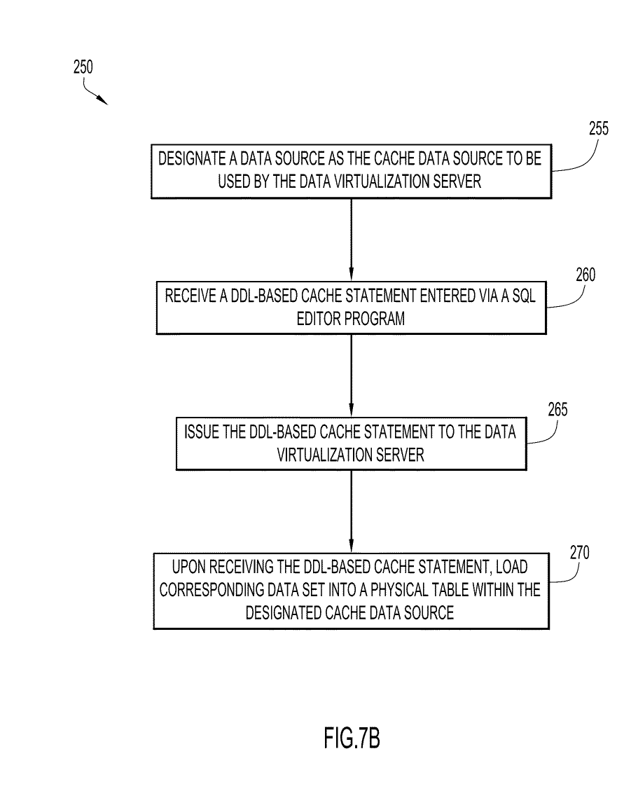

The results of any defined data view may be cached, or the cached results of a cached data view may be refreshed. FIGS. 7A and 7B are a schematic diagram and a flowchart, respectively, which illustrate the use of the DDL-based management language for caching a data view. More specifically, FIG. 7A illustrates a modification of the arrangement of FIG. 6A that further comprises a third data source 30(3) that includes a database 70(3) and physical tables 75(3). FIG. 7A also illustrates the design time client 50, the runtime client 53, the data source 30(1), the second data source 30(2), the virtual enterprise data model 20 and the data view 215.

The flowchart of FIG. 7B illustrates a caching method 250 corresponding to the arrangement of FIG. 7A. Method 250 starts at 255 where data source 30(3) is designated as the cache data source to be used by the data virtualization server 15. At 260, design time client 50 receives the following DDL-based cache statement (S11) entered by a data developer via an SQL editor.

Statement S11:

alter resource /myDataService/CaliforniaSalesVsPromotions
of type “data_view”
set materialized

As noted, the design time client 50 may be configured with a client driver program that allows the SQL editor to connect to the data virtualization server 15. As such, at 265, the DDL-based cache statement is issued to the data virtualization server 15. At 270, upon receiving the DDL-based cache statement, the data virtualization server 15 loads the data set derived from the physical tables for the virtual view (CaliforniaSalesVsPromotions) identified in the DDL-based cache statement into the cache data source (data source 30(30). Transformation into a physical table within the designated cache data source 30(3) may occur based on the transformation operations defined in the view specification. Any statistics available about the physical tables involved in the computation of the data set are leveraged to optimize the execution of the data transformations being requested.

Additionally, the cache of a data view may be removed by issuing, for example, statement S10 shown below.

Statement S12:

alter resource /myDataService/CaliforniaSales
of type “data_view”
set virtual

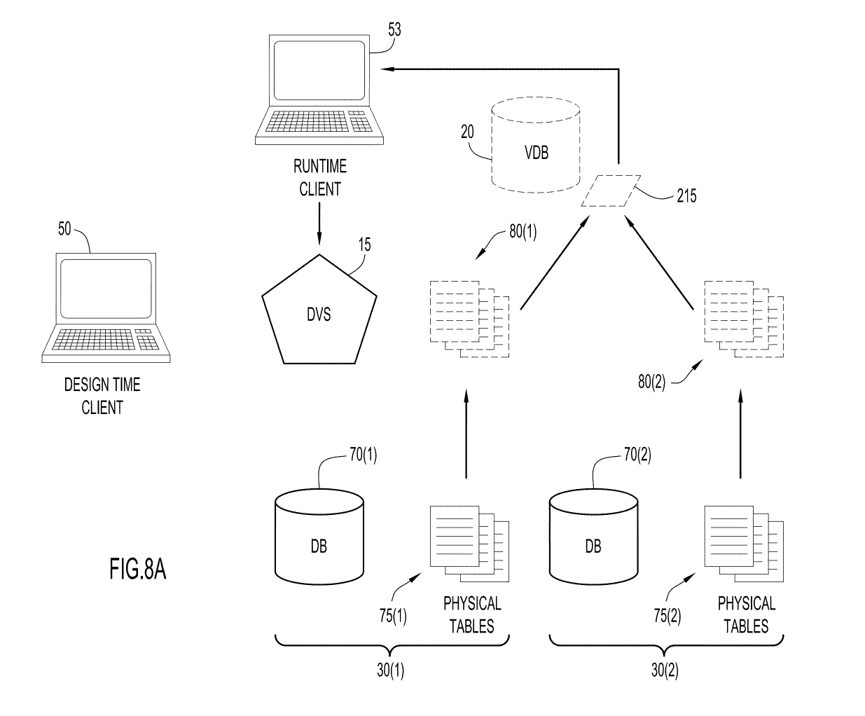

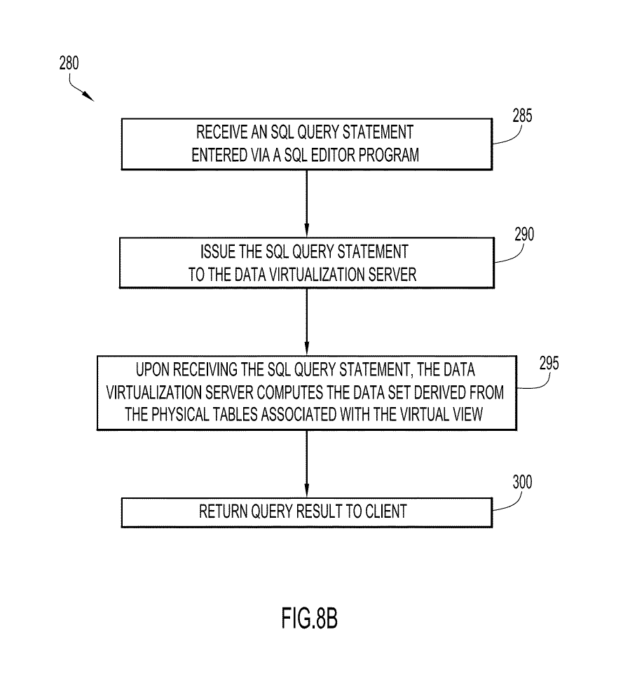

Once a virtual enterprise data model has been defined, the virtual enterprise data model may be accessed and utilized by various users. FIGS. 8A and 8B are a schematic diagram and a flowchart, respectively, which illustrate the use of the DDL-based management language for accessing a defined data view of a virtual enterprise data model. More specifically, FIG. 8A illustrates the arrangement of FIG. 6A including the virtual data view (virtual view) 215 of the virtual enterprise data model 20 at the data virtualization server 15. FIG. 8A also illustrates the design time client 50, the runtime client 53, the data source 30(1), and the second data source 30(2).

The flowchart of FIG. 8B illustrates a query method 280 corresponding to the arrangement of FIG. 8A. Method 280 starts at 285 where runtime client 53 (e.g., desktop computer, laptop computer, etc.) receives the following SQL query statement (S13) entered by a data user. The SQL query statement is received via a SQL editor program (e.g., SQuirrel SQL client)

Statement S13:

select * from CaliforniaSalesVsPromotions

In accordance with examples presented herein, the SQL query statement S13, as well as other DDL-based statements described herein, could also be auto-generated by another program, such as a business intelligence and reporting tool (BIRT) or a custom program running standalone or within an application container, that has been preconfigured with the connection information required to access the data virtualization server.

The runtime client 53 may be configured with a client driver program (e.g., JDBC driver) that allows the SQL editor to connect to the data virtualization server 15. As such, at 290, the SQL query statement is issued to the data virtualization server 15. The SQL query statement refers to one or more published virtual views. At 295, upon receiving the SQL query statement, the data virtualization server 15 computes the data set derived from the physical tables associated with the virtual views (CaliforniaSalesVsPromotions) in the received statement. Transformation is based on the transformation operations defined in the view specification. At 300, the query result is returned to the runtime client 53. Any statistics available about the physical tables involved in the computation of the query result are leveraged to optimize the execution of the requested data transformations.

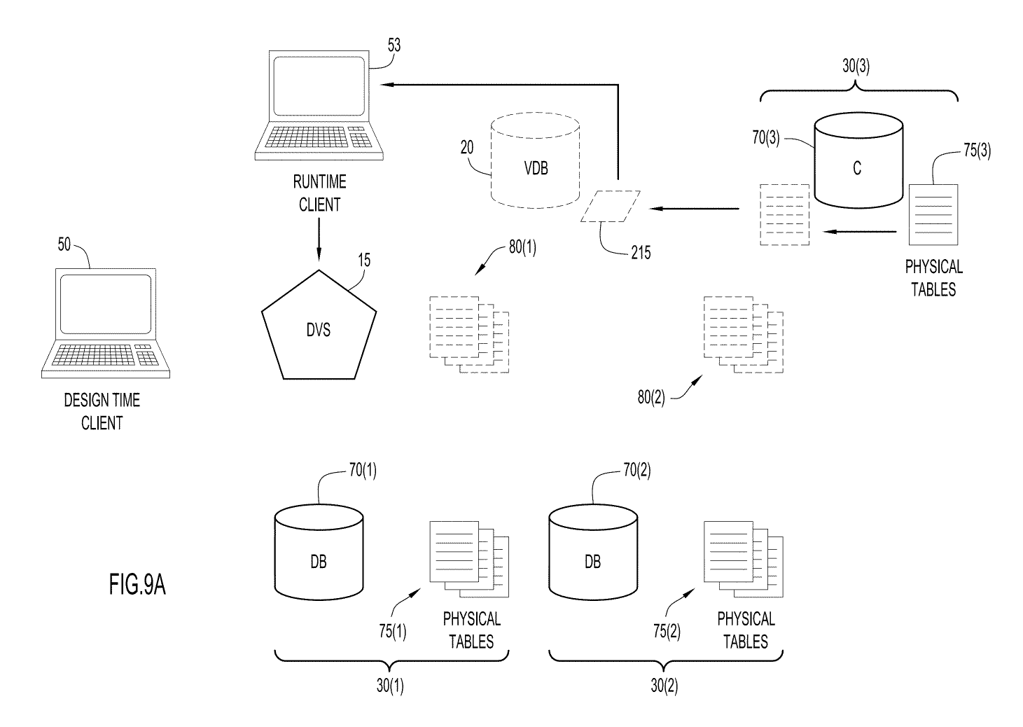

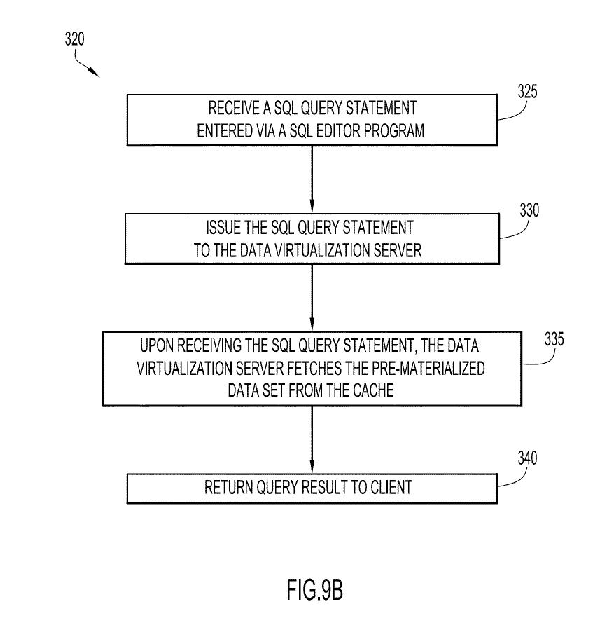

FIGS. 9A and 9B are a schematic diagram and a flowchart, respectively, which illustrate the use of the DDL-based management language for accessing cached data. More specifically, FIG. 9A illustrates the arrangement of FIG. 7A that comprises the virtual data view (virtual view) 215 of the virtual enterprise data model 20 at the data virtualization server 15, the design time client 50, the runtime client 53, the data source 30(1), the second data source 30(2), and the third data source 30(3).

The flowchart of FIG. 9B illustrates a cache access definition method 320 corresponding to the arrangement of FIG. 9A. Method 320 starts at 325 where runtime client 53 receives an SQL query statement entered by a data user via an SQL editor.

As noted, the runtime client 53 may be configured with a client driver program that allows the SQL editor to connect to the data virtualization server 15. As such, at 330, the SQL query statement is issued to the data virtualization server 15. At 335, upon receiving the SQL query statement, the data virtualization server 15 fetches the pre-materialized data set from the cache and, at 340, the data set (query result) is returned to the runtime client 53.

FIGS. 2A-9B illustrate various use cases for the declarative (DDL-based) management syntax presented herein. It is to be appreciated that these use cases are examples and that other uses for the declarative management syntax are possible.

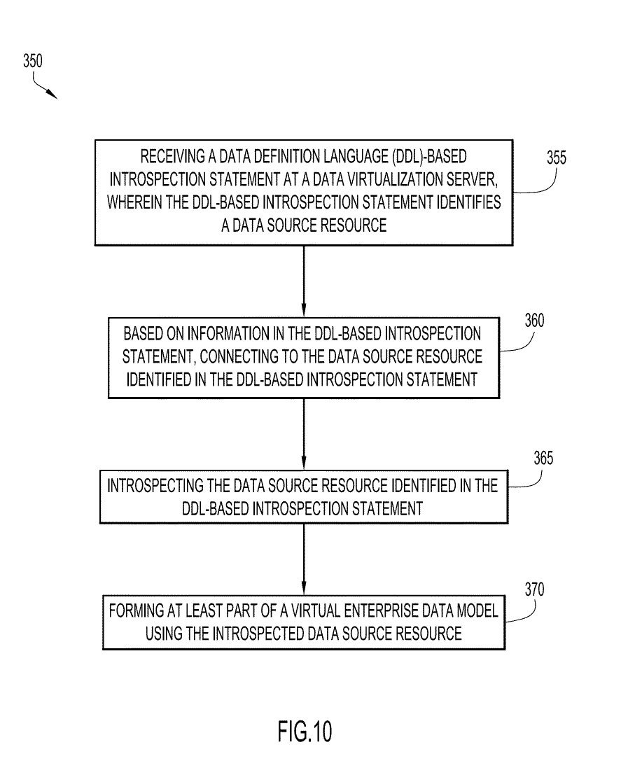

FIG. 10 is a high-level flowchart of a method 350 in accordance with examples presented herein. Method 350 begins at 355 where a data virtualization server receives a DDL-based introspection statement that identifies a data source resource. Based on information in the DDL-based introspection statement, at 360 the data virtualization server connects to the data source resource identified in the DDL-based introspection statement. At 365, the data virtualization server introspects the data source resource identified in the DDL-based introspection statement and, at 370, at least part of a virtual enterprise data model is formed by the data virtualization server using the introspected data source resource.

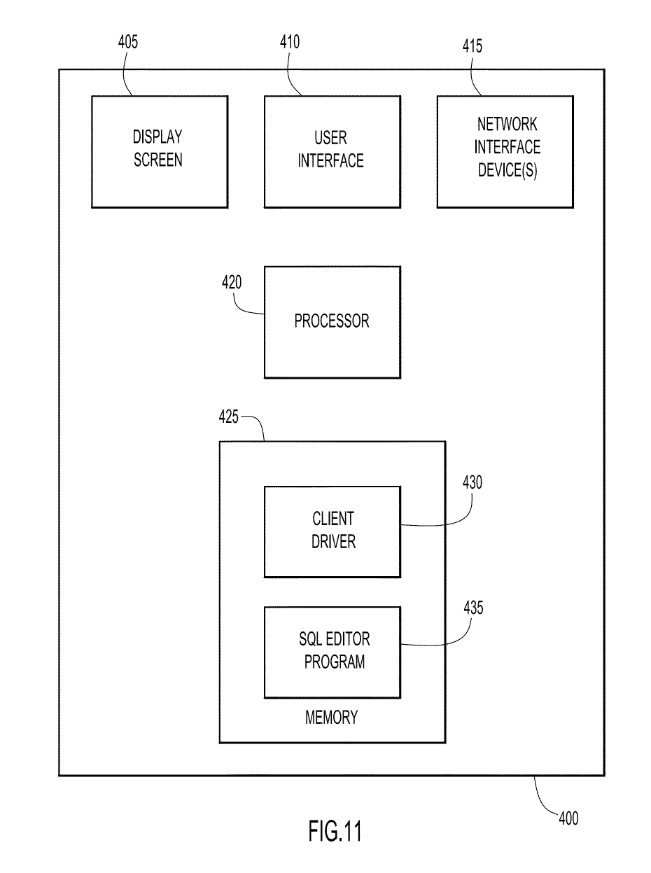

FIG. 11 is a block diagram of a client 400 in accordance with examples presented herein. The client 400 of FIG. 11 is a computer (e.g., laptop, desktop, tablet, etc.) that comprises a display screen 405, a user interface 410, network interface device(s) 415, a processor 420, and a memory 425. The memory 425 comprises a client driver 430 and an SQL editor program 435. The client driver 430 and the SQL editor program 435 collectively form a declarative management agent that enables the client 400 to issue DDL-based statements (using the DDL-based management language) to a data virtualization server for definition, control, and/or access of a virtual enterprise data model.

More specifically, the SQL editor program 435 may be executed by the processor 420 to display fields, text blocks, etc. at the display screen 405 that enable a user to edit and execute DDL statements for management of a virtual enterprise data model. The SQL editor program 435 may support features cut, copy, paste, undo, redo, find (and replace), bookmarks, block indent, print, save, etc. A user may control operation of the SQL editor program 435 via the user interface 410. The user interface 410 may comprise, for example, a keyboard, mouse, touchscreen, etc.

When a user enters a DDL-based statement via the SQL editor program 435, the client driver 430 (when executed by processor 42) is configured to connect the SQL editor program to a data virtualization server via network interface device(s) 415. As such, the entered DDL-based statement may be issued (sent) to the data virtualization server for execution.

In summary, a method is provided comprising: receiving a Data Definition Language (DDL)-based introspection statement at a data virtualization server, wherein the DDL-based introspection statement identifies a data source resource and wherein the DDL-based introspection statement uses the syntax of a DDL CREATE statement; based on information in the DDL-based introspection statement, connecting to the data source resource identified in the DDL-based introspection statement; introspecting the data source resource identified in the DDL-based introspection statement; and forming at least part of a virtual enterprise data model using the introspected data source resource.

Similarly, one or more computer readable storage media are provided encoded with software comprising computer executable instructions and when the software is executed operable to: receive a Data Definition Language (DDL)-based introspection statement at a data virtualization server, wherein the DDL-based introspection statement identifies a data source resource and wherein the DDL-based introspection statement uses the syntax of a DDL CREATE statement; based on information in the DDL-based introspection statement, connect to the data source resource identified in the DDL-based introspection statement; introspect the data source resource identified in the DDL-based introspection statement; and form at least part of a virtual enterprise data model using the introspected data source resource. As noted above, the various statements provided herein (e.g., statements S1-S13) are merely illustrative.

Further still, an apparatus is provided comprising: a network interface unit configured enable communications over a network on behalf of a data virtualization server; and a processor coupled to the network interface unit, and configured to: obtain a Data Definition Language (DDL)-based introspection statement contained in a message received by the network interface, wherein the DDL-based introspection statement identifies a data source resource and wherein the DDL-based introspection statement uses the syntax of a DDL CREATE statement; based on information in the DDL-based introspection statement, connect to the data source resource identified in the DDL-based introspection statement; introspect the data source resource identified in the DDL-based introspection statement; and create virtual tables comprising logical metadata artifacts, contained within a virtual data source stored within the data virtualization server, which reflect the properties of the introspected data source resource to form a virtual enterprise data model.

The above description is intended by way of example only. Various modifications and structural changes may be made therein without departing from the scope of the concepts described herein and within the scope and range of equivalents of the claims.

What is claimed is:

1. A computer implemented method comprising:
receiving a Data Definition Language (DDL)-based introspection statement at a data virtualization server, wherein the DDL-based introspection statement identifies a data source resource and wherein the DDL-based introspection statement uses the syntax of a DDL CREATE statement;
based on information in the DDL-based introspection statement, connecting, by the data virtualization server, to the data source resource identified in the DDL-based introspection statement;
introspecting, by the data virtualization server, the data source resource identified in the DDL-based introspection statement; and
forming, by the data virtualization server, at least part of a virtual enterprise data model using the introspected data source resource.

2. The computer implemented method of claim 1, wherein forming at least a part of the virtual enterprise data model using the introspected data source resource comprises:
creating virtual tables comprising logical metadata artifacts, contained within a virtual data source stored within the data virtualization server, which reflect the properties of the introspected data source resource.

3. The computer implemented method of claim 1, further comprising:
receiving a plurality of DDL-based introspection statements at the data virtualization server, wherein each DDL-based introspection statement identifies a data source resource for introspection by the data virtualization server.

4. The computer implemented method of claim 1, wherein receiving the DDL-based introspection statement comprises:
receiving the DDL-based introspection statement from a Structured Query Language (SQL) editor executed at a client device.

5. The computer implemented method of claim 1, further comprising:
receiving a DDL-based statistics collection statement that identifies a logical data source of the virtual enterprise data model;
connecting to a physical data source corresponding to the logical data source referenced in the DDL-based statistics collection statement; and
collecting statistics about the data contained in the physical data source,
wherein the DDL-based statistics collection statement uses the syntax of a DDL ALTER statement.

6. The computer implemented method of claim 1, further comprising:
receiving a DDL-based virtual table removal statement that identifies a logical data source of the virtual enterprise data model; and
removing all virtual tables under the virtual data source specified in the DDL-based virtual table removal statement.
wherein the DDL-based virtual table removal statement uses the syntax of a DDL DROP statement.

7. The computer implemented method of claim 1, further comprising:
receiving a first DDL-based virtual data service deployment statement identifying a virtual data service for deployment as part of the virtual enterprise data model; and
creating, in the virtual enterprise data model, an instance of the virtual data service identified in the DDL-based virtual data service deployment statement.

8. The computer implemented method of claim 7, further comprising:
receiving a DDL-based view definition statement that identifies a virtual view of the virtual data service; and
creating, in the virtual enterprise data model, an instance of the virtual view identified in the DDL-based view definition statement,
wherein the DDL-based virtual data service deployment statement and the DDL-based view definition statement each use the syntax of a DDL CREATE statement.

9. The computer implemented method of claim 1, further comprising:
mapping characteristics of the data source resource to Uniform Resource Identifier (URI) syntax components to define a declarative definition syntax used to define the virtual enterprise data model.

10. The computer implemented method of claim 1, further comprising:
employing JavaScript Object Notation (JSON) as a mechanism to capture properties of the data assets defined in the virtual enterprise data model.

11. The computer implemented method of claim 1, further comprising:
designating a data source as a cache data source for use by the data virtualization server;
receiving a DDL-based cache statement identifying a virtual view; and
loading a data set derived from physical tables corresponding to the virtual view identified in the DDL-based cache statement into the cache data source.

12. One or more computer readable storage media encoded with software comprising computer executable instructions and when the software is executed operable to:
receive a Data Definition Language (DDL)-based introspection statement at a data virtualization server, wherein the DDL-based introspection statement identifies a data source resource and wherein the DDL-based introspection statement uses the syntax of a DDL CREATE statement;
based on information in the DDL-based introspection statement, connect, by the data virtualization server, to the data source resource identified in the DDL-based introspection statement;
introspect, by the data virtualization server, the data source resource identified in the DDL-based introspection statement; and
form, by the data virtualization server, at least part of a virtual enterprise data model using the introspected data source resource.

13. The computer readable storage media of claim 12, wherein the instructions operable to form at least a part of the virtual enterprise data model using the introspected data source resource comprise instructions operable to:
create virtual tables comprising logical metadata artifacts, contained within a virtual data source stored within the data virtualization server, which reflect the properties of the introspected data source resource.

14. The computer readable storage media of claim 12, further comprising instructions operable to:
receive a plurality of DDL-based introspection statements at the data virtualization server, wherein each DDL-based introspection statement identifies a data source resource for introspection by the data virtualization server.

15. The computer readable storage media of claim 12, further comprising instructions operable to:
receive a DDL-based statistics collection statement that identifies a logical data source of the virtual enterprise data model;
connect to a physical data source corresponding to the logical data source referenced in the DDL-based statistics collection statement; and
collect statistics about the data contained in the physical data source,
wherein the DDL-based statistics collection statement uses the syntax of a DDL ALTER statement.

16. The computer readable storage media of claim 12, further comprising instructions operable to:
receive a DDL-based virtual table removal statement that identifies a logical data source of the virtual enterprise data model; and
remove all virtual tables under the virtual data source specified in the DDL-based virtual table removal statement,
wherein the DDL-based virtual table removal statement uses the syntax of a DDL DROP statement.

17. The computer readable storage media of claim 12, further comprising instructions operable to:
receive a first DDL-based virtual data service deployment statement identifying a virtual data service for deployment as part of the virtual enterprise data model; and
create, in the virtual enterprise data model, an instance of the virtual data service identified in the DDL-based virtual data service deployment statement.

18. The computer readable storage media of claim 12, further comprising instructions operable to:
receive a DDL-based view definition statement that identifies a virtual view of the virtual data service; and
create, in the virtual enterprise data model, an instance of the virtual view identified in the DDL-based view definition statement,
wherein the DDL-based virtual data service deployment statement and the DDL-based view definition statement each use the syntax of a DDL CREATE statement.

19. The computer readable storage media of claim 12, further comprising instructions operable to:
map characteristics of the data source resource to Uniform Resource Identifier (URI) syntax components to define a declarative definition syntax used to define the virtual enterprise data model.

20. The computer readable storage media of claim 16, further comprising instructions operable to:
employ JavaScript Object Notation (JSON) as a mechanism to capture properties of the data assets defined in the virtual enterprise data model.

21. The computer readable storage media of claim 16, further comprising instructions operable to:
designate a data source as a cache data source for use by the data virtualization server;
receive a DDL-based cache statement identifying a virtual view; and
load a data set derived from physical tables corresponding to the virtual view identified in the DDL-based cache statement into the cache data source.

22. An apparatus comprising:
a network interface unit configured to enable communications over a network on behalf of a data virtualization server; and
a processor coupled to the network interface unit, and configured to:
obtain a Data Definition Language (DDL)-based introspection statement contained in a message received by the network interface, wherein the DDL-based introspection statement identifies a data source resource and wherein the DDL-based introspection statement uses the syntax of a DDL CREATE statement;
based on information in the DDL-based introspection statement, connect to the data source resource identified in the DDL-based introspection statement;
introspect the data source resource identified in the DDL-based introspection statement; and
create virtual tables comprising logical metadata artifacts, contained within a virtual data source stored within the data virtualization server, which reflect the properties of the introspected data source resource to form a virtual enterprise data model.

23. The apparatus of claim 22, wherein the processor is further configured to:
obtain a first DDL-based virtual data service deployment statement identifying a virtual data service for deployment as part of the virtual enterprise data model; and
create, in the virtual enterprise data model, an instance of the virtual data service identified in the DDL-based virtual data service deployment statement.

24. The apparatus of claim 22, wherein the processor is configured to:
obtain a DDL-based view definition statement that identifies a virtual view of the virtual data service; and
create, in the virtual enterprise data model, an instance of the virtual view identified in the DDL-based view definition statement,
wherein the DDL-based virtual data service deployment statement and the DDL-based view definition statement each use the syntax of a DDL CREATE statement.

25. The apparatus of claim 22, wherein the processor is configured to:
map characteristics of the data source resource to Uniform Resource Identifier (URI) syntax components to define a declarative definition syntax used to define the virtual enterprise data model.
